(19) United States
(12) Patent Application Publication
(10) Pub. No.: US 2013/0332246 A1
(43) Pub. Date: Dec. 12, 2013

(54) DISPLAY OF ADVERTISEMENTS AT AN EVENT

(71) Applicants: Patrick John Ennis, Bellevue, WA (US); Alexander Knight, Seattle, WA (US); Vlad Grigore Dabija, Mountain View, CA (US); Timothy Martin Londergan, Seattle, WA (US); David Walter Ash, Bellevue, WA (US); Dominic Dan Suciu, Edmonds, WA (US); Raghuram Madabushi, Seattle, WA (US)

(72) Inventors: Patrick John Ennis, Bellevue, WA (US); Alexander Knight, Seattle, WA (US); Vlad Grigore Dabija, Mountain View, CA (US); Timothy Martin Londergan, Seattle, WA (US); David Walter Ash, Bellevue, WA (US); Dominic Dan Suciu, Edmonds, WA (US); Raghuram Madabushi, Seattle, WA (US)

(73) Assignee: Empire Technology Development, LLC

(21) Appl. No.: 13/699,574

(22) PCT Filed: Jun. 12, 2012
(86) PCT No.: PCT/US12/42041

§ 371 Date: Nov. 21, 2012

(51) Int. Cl. G06Q 30/02

(52) U.S. Cl. CPC G06Q 30/0252
USPC 705/14.5

(57) ABSTRACT

Technologies are generally described for processes and systems effective to select an advertisement to be displayed for viewing by participants at an event. An advertisement processor may be configured to be in communication with an advertisement database and an event status processor over a network. The advertisement processor may be effective receive event information and crowd information. The event information may relate to a status of the event. The crowd information may relate to demographics and/or interests of the participants at the event. The advertisement processor may select the advertisement based on the event information and the crowd information.

### BACKGROUND

Unless otherwise indicated herein, the materials described in this section are not prior art to the claims in this application and are not admitted to be prior art by inclusion in this section.

Two or more participants may attend an event at a location. The event may include a sporting contest, a concert, etc. Participants at the event may collectively form a crowd.

### SUMMARY

In an example, a method for selecting an advertisement to be displayed at an event is generally described. The method may include, by a processor, receiving event information. The event information may relate to a status of the event. The method may include receiving crowd information. The crowd information may relate to demographics and/or interests of participants at the event. The method may further include selecting the advertisement based on the event information and the crowd information.

In an example, a device effective to select an advertisement to be displayed for viewing by participants at an event is generally described. The device may include a memory including instructions and a processor in communication with the memory. The processor may be effective to perform the instructions in the memory to receive event information. The event information may relate to a status of the event. The processor may be effective to receive crowd information. The crowd information may relate to demographics and/or interests of the participants at the event. The processor may be effective to select the advertisement based on the event information and the crowd information.

In an example, a system effective to select an advertisement to be displayed for viewing by participants at an event is generally described. The system may include an advertisement database, a memory including instructions, an event status processor, and an advertisement processor configured to be in communication with the advertisement database, the memory and the event status processor over a network. The advertisement processor may be effective to perform the instructions in the memory to receive event information. The event information may relate to a status of the event. The advertisement processor may be effective to receive crowd information. The crowd information may relate to demographics and/or interests of the participants at the event. The advertisement processor may be effective to select the advertisement based on the event information and the crowd information.

In one example, a mobile device is generally described. The mobile device may include a screen, a memory including instructions, and a processor configured in communication with the memory and the screen. The processor may be effective to send a mobile device message to an advertisement processor. The mobile device message may indicate whether a particular participant is at a location of the event. The mobile device message may receive an advertisement in response to the mobile device message. The advertisement may be based on a status of the event and demographics and/or interests of participants at a location of the event. The mobile device may display the advertisement on the screen.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates some example systems that can be utilized to implement displaying advertisements at an event;

FIG. 2 illustrates some example systems that can be utilized to implement displaying advertisements at an event;

FIG. 3 illustrates some example systems that can be utilized to implement displaying advertisements at an event;

FIG. 4 illustrates some example systems that can be utilized to implement displaying advertisements at an event;

FIG. 5 depicts a flow diagram for example processes for implementing displaying advertisements at an event;

FIG. 6 illustrates computer program products for implementing displaying advertisements at an event; and

FIG. 7 is a block diagram illustrating an example computing device that is arranged to implement displaying advertisements at an event;

all arranged according to at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and computer program products related to displaying advertisements at an event.

Briefly stated, technologies are generally described for processes and systems effective to select an advertisement to be displayed for viewing by participants at an event. An advertisement processor may be configured to be in communication with an advertisement database and an event status processor over a network. The advertisement processor may be effective to receive event information and crowd information. The event information may relate to a status of the event. The crowd information may relate to demographics and/or interests of the participants at the event. The advertisement processor may select the advertisement based on the event information and the crowd information.

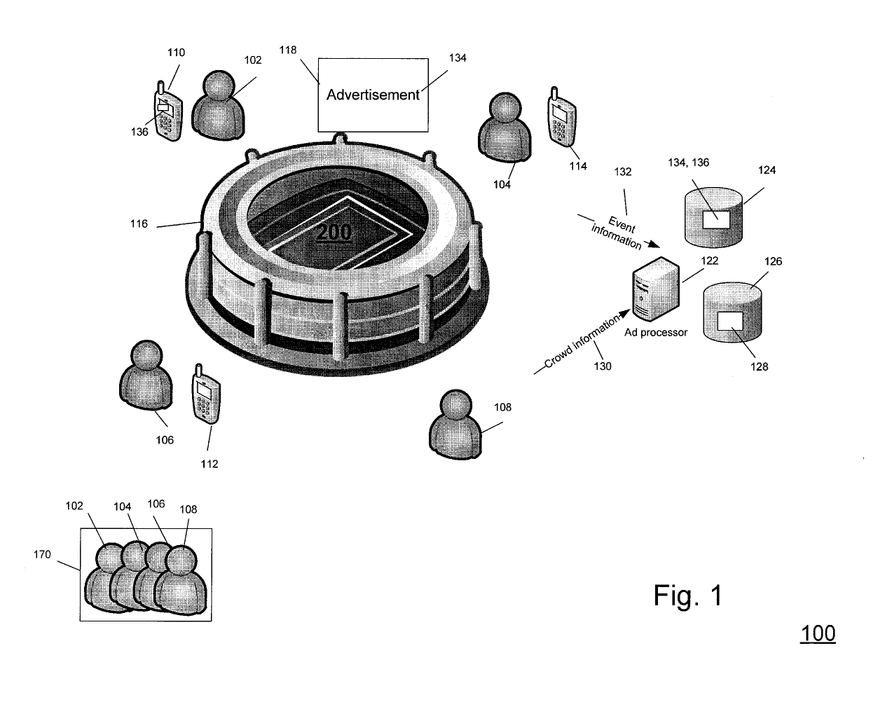

FIG. 1 illustrates some example systems that can be utilized to implement displaying advertisements at an event in accordance with at least some embodiments described herein. In some examples, as explained in more detail below, a system 100 may include two or more participants 102, 104, 106, 108 that may collectively form a crowd 170 for an event 200 at a location 116. Some participants 102, 104, 106 may be in communication with or otherwise using respective mobile devices 110, 112, 114. An advertisement processor 122 may receive crowd information 130 relating to participants 102, 104, 106, 108 at event 200. Advertisement processor 122 may also receive event information 132 relating to a status of event 200. Advertisement processor 122 may select one or more advertisements 134, 136 from an advertisement database 124 based on event information 132, crowd information 130, and instructions 128 in a memory 126. Advertisement processor 122 may cause advertisement 134 to be displayed for viewing on a billboard 118 and advertisement 136 to be displayed on one or more mobile devices 110, 112, and/or 114.

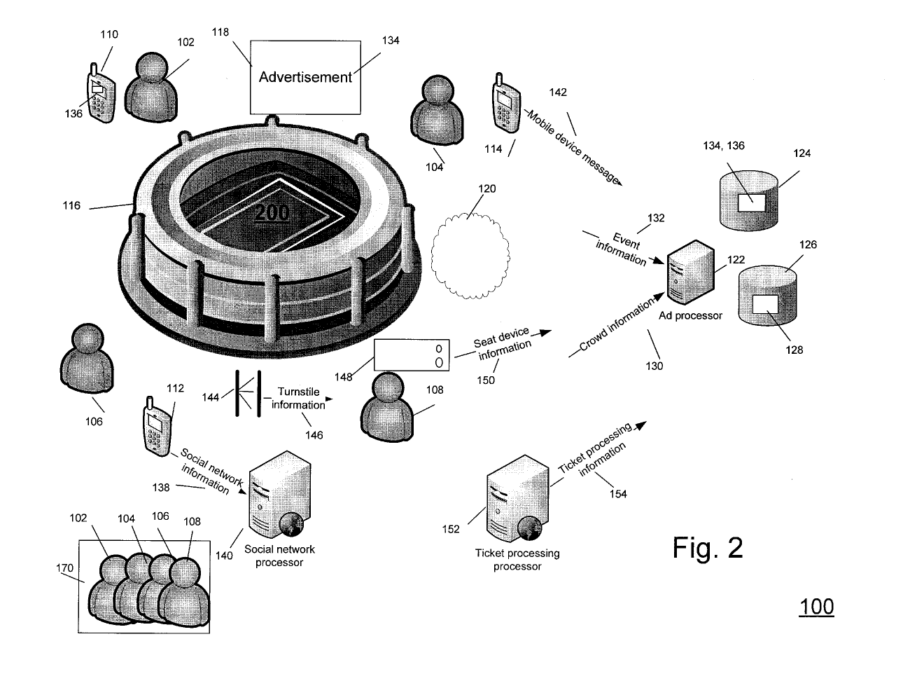

FIG. 2 illustrates some example systems that can be utilized to implement displaying advertisements at an event in accordance with at least some embodiments described herein. Those components in FIG. 2 that are labeled identically to components of FIG. 1 will not be described again for the purposes of clarity.

Billboard 118 may be configured in communication with advertisement processor 122 through network 120. Similarly, advertisement processor 122 may receive event information 132 and/or crowd information 130 through network 120. Crowd information 130 may be generated from a variety of sources. For example, a participant 106 may generate social network information 138 indicating that the participant is attending, or plans to attend, event 200. Social network information 138 may include a post on a social network site, a “check-in” through a social network application etc. For example social network information 138 may indicate that participant 106 is checking in to event 200 at location 116. Advertisement processor 122 may receive social network information 138 from a social network processor 140. For example, advertisement processor 122 may be configured to crawl a site or sites controlled by social network processor 140. Participants may opt in and allow advertisement processor 122 to receive information from social network processor 140. Social network processor 140 may sell social network information 138 to advertisement processor 122. Social network information 138 may include information relating to participant 106. For example, social network information 138 may identify demographics of participant 106, interests of participant 106, etc. Demographics may include, for example, age, gender, income level, sexual orientation, job status, residence, occupation, nationality, whether they own, rent or live with parents, personal assets, etc.

Advertisement processor 122 may be configured to determine mobile devices that are present at location 116. For example, even if a participant indicates in social network information 138 that he or she plans to attend the event, the participant may not actually attend the event. Similarly, participants may show up to event 200 without providing social network information 138. Advertisement processor 122 may determine mobile devices present at location 116 such as by receiving one or more mobile device messages 142 indicating that the mobile devices are present at location 116. Mobile device message 142 may further include information about participant 104 such as demographics, interests, etc. As mobile device message 142 is generated by mobile devices at location 116, mobile device message 142 may change over the course of the event. Mobile device message 142 may thus indicate whether participants stayed at location 116 for the entire event, came late to the event, left early before event 200 ended, etc. Advertisement processor 122 may also identify mobile devices at location 116 through social network information 138. For example, participants may post photographs or other social network information 138 including geography coordinates relating to location 116.

Participants may purchase tickets for event 200 from a ticket processing processor 152. During the purchase, participants may provide information relating to the participants such as demographics and/or interests of the participants. Advertisement processor 122 may receive ticket processing information 154 including information provided by participants when the participants purchase tickets to event 200. Ticket processing processor 152 may be run by a host running event 200 or could be run by a third party ticket processing service.

A seat device 148 may be disposed in or near seats of participants. Participants may enter information in seat device 148 relating to demographics or interest of participants. Seat device 148 may generate seat device information 150 and send seat device information 150 to advertisement processor 122. A turnstile 144 may receive information relating to demographics of participants when participants purchase tickets at, or come to, location 116. Turnstile 144 may produce turnstile information 146 that may be received by advertisement processor 122.

Crowd information 130 may include social network information 138, mobile device message 142, seat device information 150, turnstile information 146, and/or ticket processing information 154. Some of the information received by advertisement processor 122 may be sold to advertisement processor 122. Crown information 130 may thus relate to demographics and/or interests of participants at event 200.

Advertisement processor 122 may process crowd information 130 to select an advertisement 134, 136 in database 124. For example, advertisement processor 122 may use instructions 128 to process crowd information 130. In processing crowd information 130, advertisement processor 122 may prioritize and/or more heavily weigh turnstile information 146, seat device information 150 and/or ticket processing information 154 higher than other information. The heavier weighing is because this information may have a better chance of reflecting the crowd at location 116. Information relating to whether participants plan to attend event 200 in social network information 138 may be less reliable than information relating to participants at location 116.

Over the course of event 200, advertisement processor 122 may process crowd information 130 differently. For example, prior to event 200 and during an early part of event 200, ticket processing information 154 and social network information 138 may be weighed heavier as this information may reflect whether participants intend to come to event 200. Once event 200 starts, mobile device messages 142 and seat device information 150 may be weighed heavier as this information may reflect participants actually at event 200 instead of participants who intended to attend event 200. Advertisement processor 110 may weigh information from greater numbers of participants who share their information. For example, if only 5 mobile devices provide mobile device messages 142, such information may be less reliable than other sources of information and may be weighed less when advertisement processor 122 processes crowd information 130.

Crowd information 130 may assist advertisement processor 122 in selecting advertisements tailored to crowd 170. For example, crowd information 130 may indicate that many participants from a visiting team are at event 200—such as through social network information 138. Advertisements 134, 136 may be selected to provide advertisements for visiting team participants but not to offend home team participants. Crowd information 130 may also reflect how a crowd responds to a particular advertisement and may be used to tailor subsequent advertisements. For example, social network information 138 may indicate whether crowd 170 likes a particular advertisement and subsequent advertisements may be selected in response to the crowd's reaction.

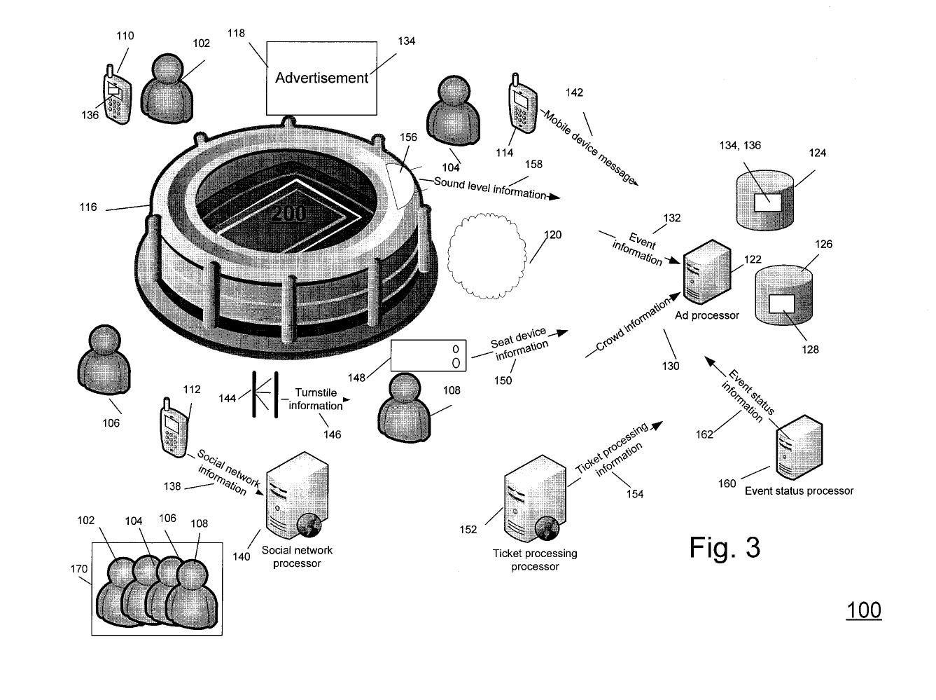

FIG. 3 illustrates some example systems that can be utilized to implement displaying advertisements at an event in accordance with at least some embodiments described herein. Those components in FIG. 3 that are labeled identically to components of FIGS. 1 and 2 will not be described again for the purposes of clarity.

Advertisement processor 122 may further receive and process event information 132. For example, an event status processor 160 may obtain event stratus information 162 relating to a current activity of event 200. For example, event status information 162 may indicate whether a home or visiting team just scored, whether a football team has chosen to attempt a play on fourth down, etc. Depending on a status of an event, advertisement processor 122 may select a different, or no advertisement.

Advertisement processor 122 may receive other event information 132 relating to a status of event 200. For example, advertisement processor 122 may receive information relating to a sound level at event 200. A microphone 156 may receive a crowd noise level and generate sound level information 158. Advertisement processor 122 may receive sound level information 158 as part of event information 132.

Advertisement processor 122 may also receive social network information 138 as part of event information 132. For example, participants may generate postings and/or alter an amount of social network chatter based on a status of event 200. For example, at a very intense moment during event 200, participants may post less chatter in social network information 138 than during slower more boring moments. Instructions 128 may indicate that slower moments may be more conducive to displaying advertisements or that different advertisements should be displayed depending on the interest level of the event.

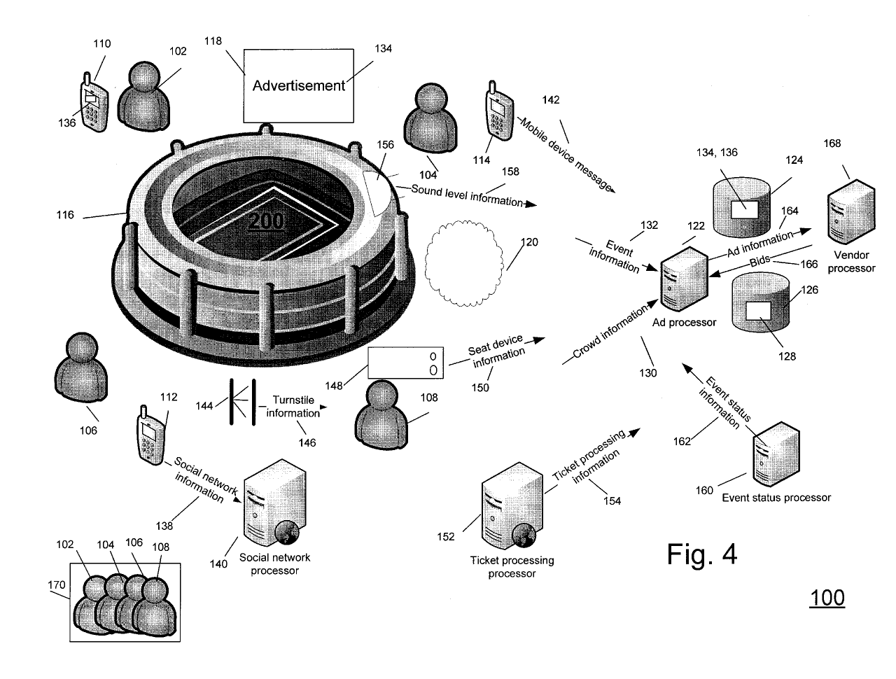

FIG. 4 illustrates some example systems that can be utilized to implement displaying advertisement at an event in accordance with at least some embodiments described herein. Those components in FIG. 4 that are labeled identically to components of FIGS. 1, 2 and 3 will not be described again for the purposes of clarity.

Advertisement processor 122 may receive and process event information 132 and crowd information 130 and produce advertisement information 164. One or more vendor processors 168 may receive advertisement information 164 and may place one or more bids 166 for advertisements to be displayed for viewing by participants. Bids may be based on a composition of crowd 170 and/or a status of event 200. For example, vendors may choose to big higher or lower for the opportunity to display an advertisement based on a demographic of crowd 170. For example, if event status information 162 indicates that an injury time-out has occurred during event 200, vendor processor 168 may be configured to increase a bid for advertisements relating to pain relievers. Similarly, bids may be affected by social network information 138, or other information in advertisement information 164.

Among other possible benefits, using a system in accordance with the disclosure, advertisements may be selected and displayed to participants at an event. A participant's experience at an event may be modified based on their social network information. Using event information and crowd information, an advertisement processor may select and display advertisements. Advertisements may be selected based on the mood of participants and displayed on the participant's mobile devices. Advertisements may be selected based on the mood of the crowd at an event and displayed on a billboard. As information relating to the crowd may change over time, advertisements displayed may change to reflect the changing demographics and/or composition of the crowd. Advertisements displayed for viewing by participants may be more specifically chosen for the participants as granular information is available.

Crowd demographics may vary widely and the composition may not be known in advance. For example, a day game may have a different demographics than a night game. A game may have a large contingent of participants from another city for the visiting team. The weather at the event may affect the crowd composition. An ad hoc social network may be created from participants at an event. A social network may be created based on information gathered during an event and the network may be broken after the event is over.

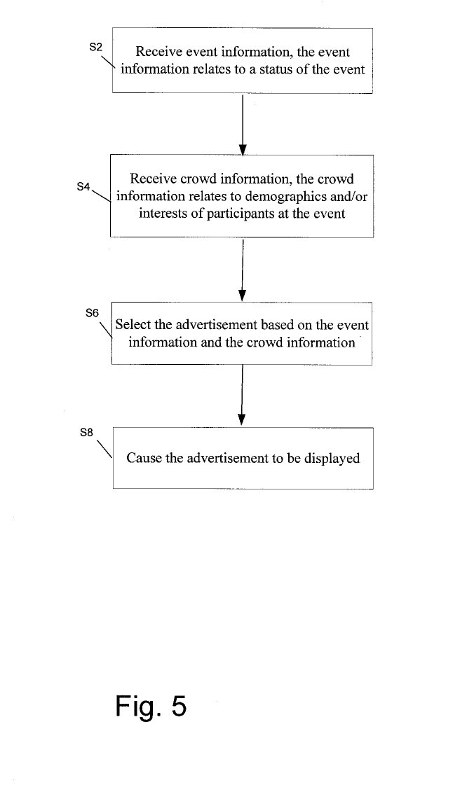

FIG. 5 depicts a flow diagram for example processes for implementing displaying advertisements at an event in accordance with at least some embodiments described herein. The process in FIG. 5 could be implemented using, for example, system 100 discussed above. An example process may include one or more operations, actions, or functions as illustrated by one or more of blocks S2, S4, S6, and/or S8. Although illustrated as discrete blocks, various blocks may be divided into additional blocks, combined into fewer blocks, or eliminated, depending on the desired implementation.

Processing may begin at block S2, “Receive event information, the event information relates to a status of the event.” At block S2, an advertisement processor may receive event information. The event information may relate to a status of the event such as current activity, a sound level, or social network information relating to the event.

Processing may continue from block S2 to block S4, “Receive crowd information, the crowd information relates to demographics and/or interests of participants at the event.” At block S4, the advertisement processor may receive crowd information. The crowd information may relate to demographics and/or interests of participants at the event. The crowd information may include social network information such as whether a participant plans to attend or is attending the event. The crowd information may include geography coordinates of mobile devices at the location of the event. The crowd information may include ticket processing information or turnstile information based on purchase of tickets for the event. The crowd information may be received from a seat device.

Processing may continue from block S4 to block S6, “Select the advertisement based on the event information and the crowd information.” At block S6, the advertisement processor may select an advertisement based on the event information and the crowd information. The advertisement may be selected based on participants indicated as being present at a location of the event at a particular time. The advertisement processor may select the advertisement based on information received relating to a prior displayed advertisement.

Processing may continue from block S6 to block S8, “Cause the advertisement to be displayed.” At block S8, the advertisement processor may cause the advertisement to be displayed. For example, the advertisement processor may cause the advertisement to be displayed on a mobile device or on a billboard at a location of the event.

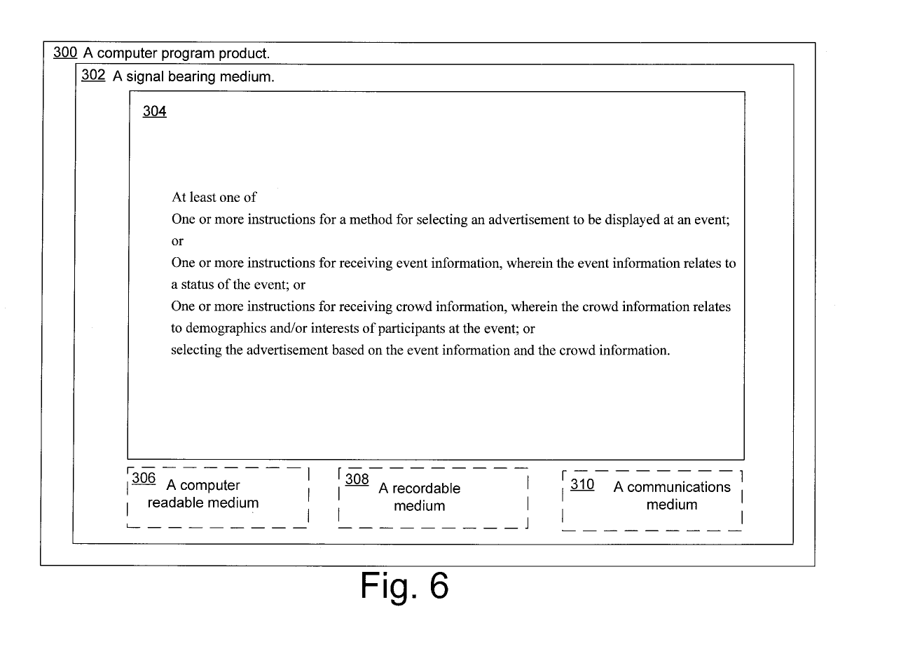

FIG. 6 illustrates computer program products 300 for implementing displaying advertisements at an event in accordance with at least some embodiments described herein. Program product 300 may include a signal bearing medium 302. Signal bearing medium 302 may include one or more instructions 304 that, when executed by, for example, a processor, may provide the functionality described above with respect to FIGS. 1-5. Thus, for example, referring to system 100, advertisement processor 122 may undertake one or more of the blocks shown in FIG. 6 in response to instructions 304 conveyed to the system 100 by medium 302.

In some implementations, signal bearing medium 302 may encompass a computer-readable medium 306, such as, but not limited to, a hard disk drive, a Compact Disc (CD), a Digital Video Disk (DVD), a digital tape, memory, etc. In some implementations, signal bearing medium 302 may encompass a recordable medium 308, such as, but not limited to, memory, read/write (R/W) CDs, R/W DVDs, etc. In some implementations, signal bearing medium 302 may encompass a communications medium 310, such as, but not limited to, a digital and/or an analog communication medium (e.g., a fiber optic cable, a waveguide, a wired communications link, a wireless communication link, etc.). Thus, for example, program product 300 may be conveyed to one or more modules of the system 100 by an RF signal bearing medium 302, where the signal bearing medium 302 is conveyed by a wireless communications medium 310 (e.g., a wireless communications medium conforming with the IEEE 802.11 standard).

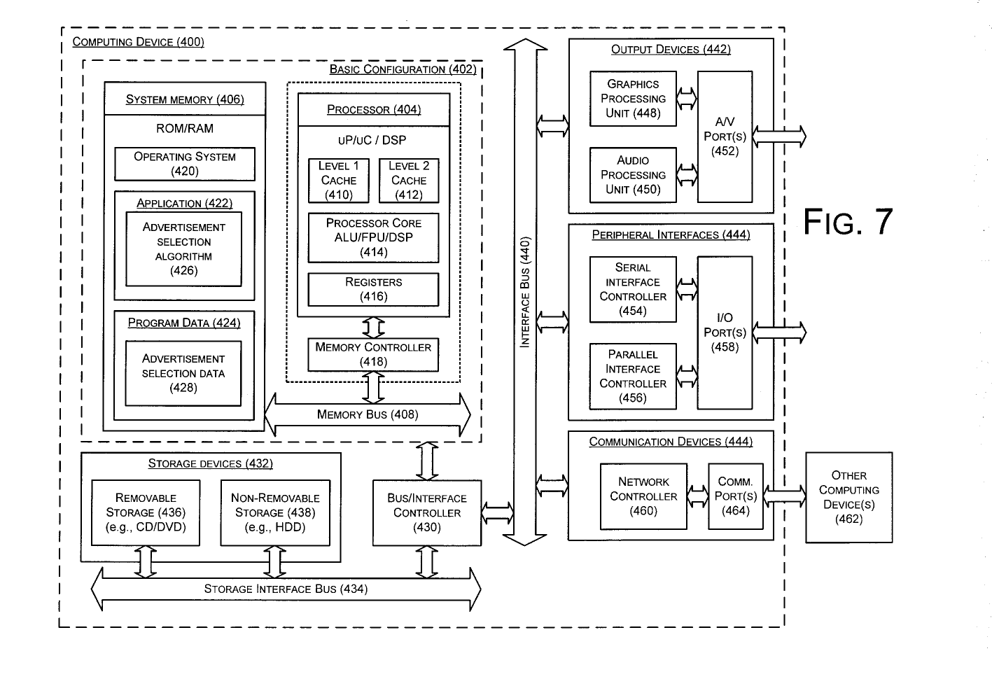

FIG. 7 is a block diagram illustrating an example computing device 400 that is arranged to implement displaying advertisements at an event in accordance with at least some embodiments described herein. In a very basic configuration 402, computing device 400 typically includes one or more processors 404 and a system memory 406. A memory bus 408 may be used for communicating between processor 404 and system memory 406.

Depending on the desired configuration, processor 404 may be of any type including but not limited to a microprocessor (μP), a microcontroller (μC), a digital signal processor (DSP), or any combination thereof. Processor 404 may include one more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof An example memory controller 418 may also be used with processor 404, or in some implementations memory controller 418 may be an internal part of processor 404.

Depending on the desired configuration, system memory 406 may be of any type including but not limited to volatile memory (such as RAM), non-volatile memory (such as ROM, flash memory, etc.) or any combination thereof System memory 406 may include an operating system 420, one or more applications 422, and program data 424.

Application 422 may include an advertisement selection algorithm 426 that is arranged to perform the functions as described herein including those described previously with respect to FIGS. 1-6. Program data 424 may include advertisement selection data 428 that may be useful for implementing displaying advertisements at an event as is described herein. In some embodiments, application 422 may be arranged to operate with program data 424 on operating system 420 such that displaying advertisements at an event may be provided. This described basic configuration 402 is illustrated in FIG. 7 by those components within the inner dashed line.

Computing device 400 may have additional features or functionality, and additional interfaces to facilitate communications between basic configuration 402 and any required devices and interfaces. For example, a bus/interface controller 430 may be used to facilitate communications between basic configuration 402 and one or more data storage devices 432 via a storage interface bus 434. Data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 406, removable storage devices 436 and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 440 for facilitating communication from various interface devices (e.g., output devices 442, peripheral interfaces 444, and communication devices 446) to basic configuration 402 via bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method for selecting an advertisement to be displayed at an event, the method comprising, by a processor:
receiving event information, wherein the event information relates to a status of a current activity of the event;
receiving crowd information, wherein the crowd information relates to demographics and/or interests of participants at the event; and
selecting the advertisement based on the event information and the crowd information.

2. The method of claim 1, further comprising causing the advertisement to be displayed for viewing by at least one of the participants.

3. The method of claim 1, further comprising causing the advertisement to be displayed for viewing by at least one of the participants on a mobile device.

4. (canceled)

5. The method of claim 1, wherein the crowd information includes social network information relating to the participants.

6. (canceled)

7. The method of claim 1, wherein:
the crowd information includes social network information relating to the participants; and
the social network information includes an indication that at least one participant is currently attending the event.

8. The method of claim 1, wherein:
the crowd information includes social network information relating to the participants; and
the social network information includes a check-in at a location of the event.

9. (canceled)

10. The method of claim 1, wherein:
the crowd information includes social network information relating to the participants; and
the social network information includes geography coordinates that relate to a location of the event, wherein the geography coordinates indicate that a particular mobile device and a particular participant are present at a location of the event.

11. (canceled)

12. The method of claim 1, further comprising:
receiving a mobile device message, wherein the mobile device message indicates that a particular mobile device and a particular participant are present at the event; and wherein
the crowd information includes the mobile device message.

13. (canceled)

14. (canceled)

15. The method of claim 1, wherein the crowd information includes ticket processing information or turnstile information, the ticket processing information or turnstile information being based on purchase of tickets for the event.

16. The method of claim 1, wherein the crowd information includes seat device information, wherein the seat device information is received from a particular participant at a particular seat in a location of the event.

17. The method of claim 1, wherein:
the crowd information includes one or more of social network information, a mobile device message, seat device information, turnstile information and/or ticket processing information;
the social network information includes an indication that at least one of the participants plans to attend or is currently attending the event;
the social network information identifies the demographics and/or interests of at least one of the participants;
the mobile device message indicates that a particular mobile device and a particular participant are present at the event;
the seat device information is received from one of the participants at a seat in a location of the event;
the turnstile information is based on purchase of tickets for the event; and
the ticket processing information is based on purchase of tickets for the event.

18. (canceled)

19. (canceled)

20. (canceled)

21. The method of claim 1, wherein the event information relates to a sound level at the event.

22. The method of claim 1, wherein the event information includes social network information relating to the event.

23. (canceled)

24. The method of claim 1, further comprising:
processing the event information and the crowd information to produce advertisement information; and
receiving a bid to display the advertisement, wherein the bid is based on the advertisement information.

25. A device effective to select an advertisement to be displayed for viewing by participants at an event, the device comprising:
a memory including instructions; and
a processor in communication with the memory, the processor effective to perform the instructions in the memory to:
receive event information, wherein the event information relates to a status of a current activity of the event;
receive crowd information, wherein the crowd information relates to demographics and/or interests of the participants at the event; and
select the advertisement based on the event information and the crowd information.

26. The device of claim 25, wherein the processor is further effective to cause the advertisement to be displayed for viewing by at least one of the participants.

27. The device of claim 25, wherein the processor is further effective to cause the advertisement to be displayed for viewing by at least one of the participants on a mobile device.

28. (canceled)

29. (canceled)

30. (canceled)

31. (canceled)

32. (canceled)

33. (cancelled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. The device of claim 25, wherein the processor is further effective to:
process the event information and the crowd information to produce advertisement information; and
receive a bid to display the advertisement, wherein the bid is based on the advertisement information.

49. A system effective to select an advertisement to be displayed for viewing by participants at an event, the system comprising:
an advertisement database;
a memory including instructions;
an event status processor; and
an advertisement processor configured to be in communication with the advertisement database, the memory and the event status processor over a network, the advertisement processor effective to perform the instructions in the memory to:
receive event information, wherein the event information relates to a status of a current activity of the event;
receive crowd information, wherein the crowd information relates to demographics and/or interests of the participants at the event; and
select the advertisement based on the event information and the crowd information.

50. The system of claim 49, wherein the processor is further effective to cause the advertisement to be displayed for viewing by at least one of the participants.

51. A mobile device comprising:
a screen;
a memory including instructions;
a processor configured in communication with the memory and the screen, the processor effective to:
send a mobile device message to an advertisement processor, wherein the mobile device message indicates whether a particular participant is at a location of the event;
receive an advertisement in response to the mobile device message, the advertisement being based on a status of a current activity of the event and demographics and/or interests of participants at a location of the event; and
display the advertisement on the screen.

52. The mobile device of claim 51, wherein the processor is further effective to send the mobile device message to the advertisement processor, wherein the mobile device message includes information relating to demographics and/or interests of the particular participant at the event.
